(19) United States
(12) Patent Application Publication
(10) Pub. No.: US 2005/0062723 A1
(43) Pub. Date: Mar. 24, 2005

(54) Ergonomic keyboard

(76) Inventor: Chua-Chia Tsai, Taipei Hsien (TW)

Correspondence Address: MICHAEL D. BEDNAREK;SHAW PITTMAN LLP, 1650 TYSONS BLVD., MCLEAN, VA, 22102, US

(21) Appl. No.: 10/922,926

(22) Filed: Aug. 23, 2004

Related U.S. Application Data
(63) Continuation-in-part of application No. 09/973,910, filed on Oct. 11, 2001, now abandoned.

(30) Foreign Application Priority Data
Oct. 13, 2000 (TW) 089121756

(51) Int. Cl. G09G 5/00

(52) U.S. Cl. 345/168

(57) ABSTRACT

An ergonomic keyboard includes a base and a plurality of keys that is further arranged into a plurality of adjacent key rows. The key rows having letter keys and numeral keys are equal-spaced arranged on the base to form adjacent concentric arcs with a concentric center located opposing to a user side of the keyboard. Further, the letter keys and the numeral keys are identically shaped and are evenly arranged into the adjacent key rows.

### BACKGROUND OF THE INVENTION

This application is a continuation-in-part of application Ser. No. 09/973,910 filed Oct. 11, 2001.

(1) Field of the Invention

The invention relates to an ergonomic keyboard, and more particularly to the ergonomic keyboard for notebook computers which can increase user comfort with the keyboard and can minimize the harm from using keyboards.

(2) Description of the Prior Art

Due to tremendous cost down upon the materials and the manufacturing in the notebook computer industry, the market share of the notebook computers in the computer market has been greatly increased. However, a limited room provided for accommodating a keyboard has caused user discomfort with his/her notebook computer. It is well known that a typewriter or a computer in the art has a keyboard with four adjacent linear and parallel key rows for constructing a plurality of keys. Generally in a conventional keyboard structure, the first key row is used to arrange numeral keys and the other three key rows are left for letter keys. The letter keys of a standard keyboard are arranged in accordance with a “QWERTY” standard keyboard arrangement. The “QWERTY” standard keyboard can be easily identified by the first letter key row of the keyboard which presents Q-W-E-R-T-Y- . . . from left to right. Further, those four key rows are arranged with a small position shift from row to row, and thereby the typing stroke can be shortened, for a lengthy typing stroke always leads to muscle strain and fatigue upon user's wrist. Conventional linear and parallel type keyboards usually keep user's hands at an unnatural position which makes the user to approach his/her wrists and type the keys by out-rotating his/her wrists. Therefore, the user of the standard keyboard is usually subjected to a high possibility of repetitive stress injury (RSI). As an effort to resolve the shortcomings of the conventional keyboards, U.S. Pat. No. 5,360,280 introduced an ergonomic keyboard with a structure bumping toward the user. The ergonomic keyboard included a left portion, a bent portion and a right portion. In the bent portion, at least two elongated keys were provided to help the user's wrist maintained at a natural typing position.

Though U.S. Pat. No. 5,360,280 does have the keys on the keyboard arranged ergonomically, yet the possibility of muscle fatigue of the user is increased by its extended typing stroke. Furthermore, for a keyboard manufacturer, different shapes of keys imply that a huge tooling cost is inevitable and also the assembly of the keyboard is labor-consuming.

### SUMMARY OF THE INVENTION

Accordingly, it is a primary object of the present invention to provide an ergonomic keyboard which can maintain the user's wrist at a natural typing position. The ergonomic keyboard of the present invention includes a base and a plurality of keys arranged into a plurality of consecutive adjacent rows. The consecutive adjacent rows with letter and numeral keys are arranged on the base as equal-spaced concentric arc rows. The concentric center of the arc rows is located at a location of the center line of the base opposing to the user of the keyboard.

It is another object of the present invention to provide an ergonomic keyboard which includes letter keys and numeral keys with an identical size and whose keys are evenly arranged at the consecutive adjacent arc rows, so that the production cost can be reduced and the manufacturing yield can be increased.

It is a further object of the present invention to provide a keyboard for a notebook computer which arranges the frequent-use keys into a central area of the base with a preferable compact arrangement, while the less-use keys are arranged to the periphery of the base with a restricted-room arrangement, so that the keyboard of the notebook computer can be provided ergonomically.

It is still an object of the present invention to provide a replaceable ergonomic keyboard for a notebook computer which includes a fastener located at one side thereof for engaging the keyboard into the computer unit. Thereby, the user can replace his/her keyboard as desired.

All these objects are achieved by the ergonomic keyboard described below.

### BRIEF DESCRIPTION OF THE DRAWINGS

The present invention will now be specified with reference to its preferred embodiment illustrated in the drawings, in which

FIG. 1 is a perspective view of a preferred notebook computer in accordance with the present invention;

FIG. 2 is a top view of a preferred ergonomic keyboard in accordance with the present invention;

FIG. 3 shows the key arrangement of the preferred ergonomic keyboard of FIG. 2; and

FIG. 4 shows a cross-sectional view alone line A-A of FIG. 3.

### DESCRIPTION OF THE PREFERRED EMBODIMENT

The invention disclosed herein is directed to an ergonomic keyboard. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

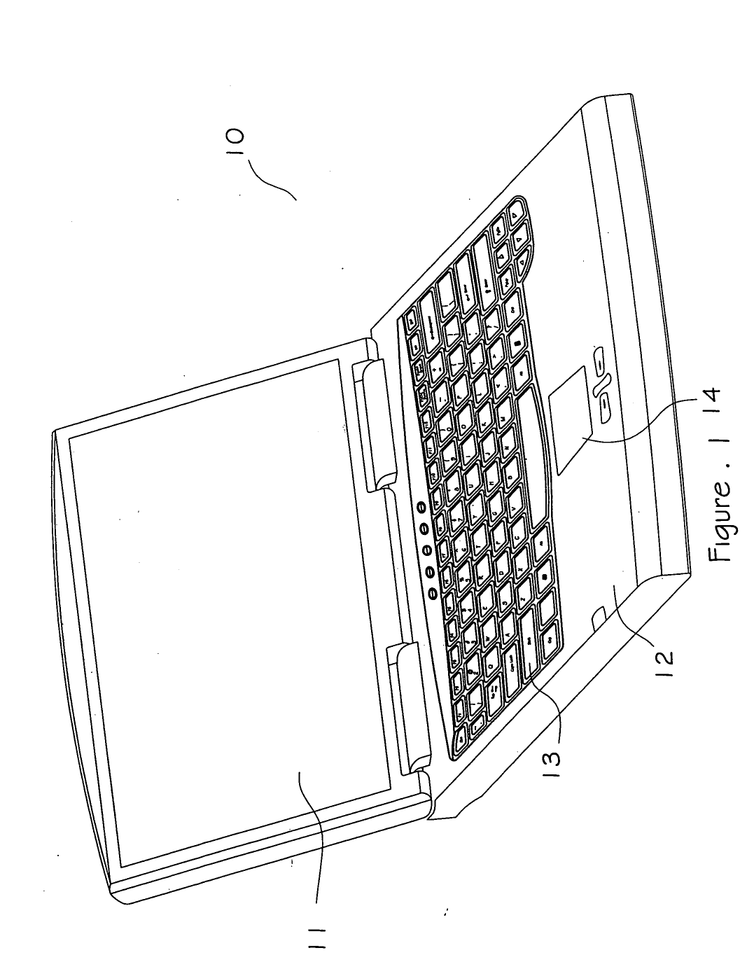

Referred now to FIG. 1, a perspective view of a preferred notebook computer in accordance with the present invention is shown. The notebook computer 10 comprises a display unit 11, a computer unit 12, a keyboard 13 and a touch pad 14 constructed on the computer unit 12. The computer unit 12 further comprise memory, processors, storage media and other devices for data processing. The display unit 11 is used to output the results of the data processing. The keyboard 13 and the touch pad 14 are both the input device.

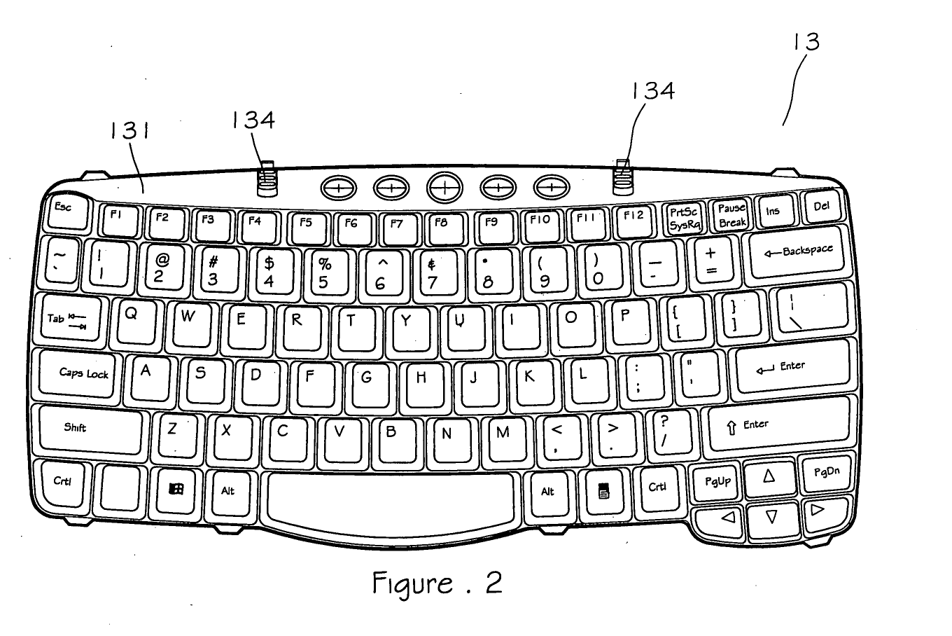

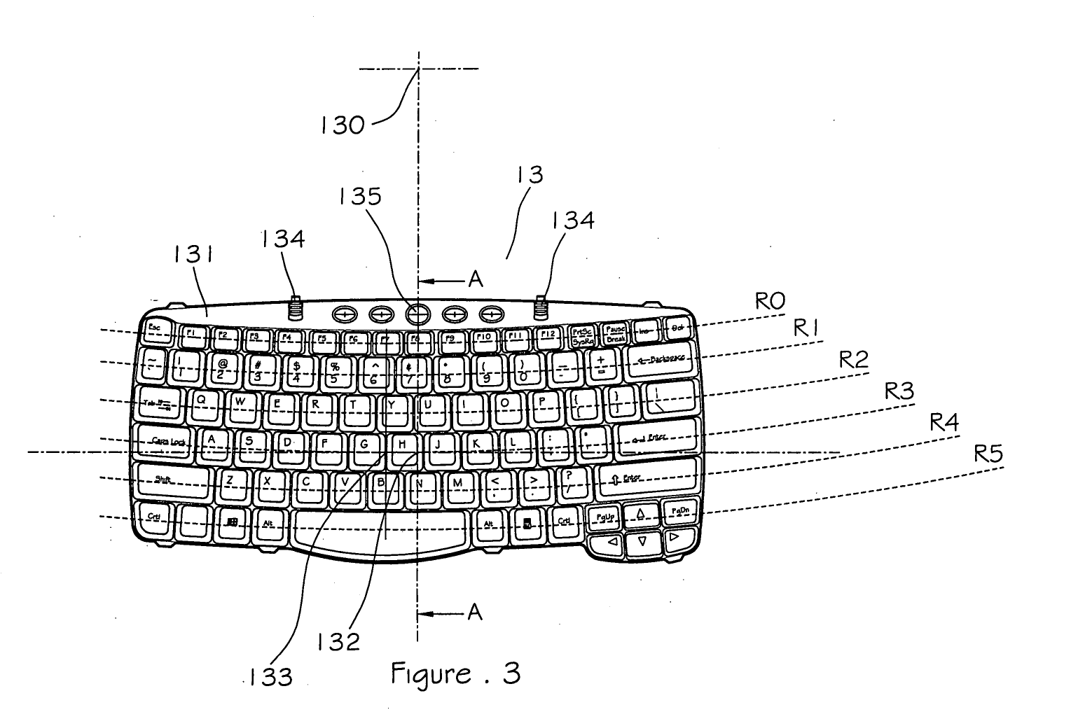

Referring now to FIG. 2 and FIG. 3, a top view of the preferred keyboard 13 and a schematic view of the key arrangement of the keyboard 13 in accordance with the present invention are respectively shown. Thereby, detail explanation upon the keyboard arrangement of the present invention can be followed. As shown, the keyboard 13 comprises a base 131 and a plurality of keys arranged on top thereof. The keys are allotted to consecutive adjacent rows which are located almost parallel to each other on the base 131. The order arrangement of the keys are the same as that for the conventional keyboard, so that the user of the present keyboard does not need to change his/her typing style. In addition, a pair of fasteners 134 are introduced to an upper edge of the base 131, for fixing the keyboard 13 to a predetermined position on the computer unit 12. Because the fastener 134 is replaceable, the keyboard 13 can be easily removed from the notebook computer 10 for replacement. According to some statistics, it is interesting to know that the most vulnerable parts in the notebook computer 10 are the display unit 11 and the keyboard 13. Therefore, the advantages of easy installation and easy disassembly provided by the keyboard of the present invention can be positive to increase the life time of the notebook computer 10. Furthermore, on the basis of locating keys evenly toward a center line of the base for the purpose of reducing the space between the adjacent keys, the present invention designs the width of each keys of said “QWERTY” standard keyboard arrangement is increasing radically from said concentric center.

For the notebook computer 10, the computer unit 12 can only provide limited surface space, and so the size of the key on the notebook computer cannot be compared to that on a desktop computer. It is obvious that the notebook computer will have less portability if the key thereof is made equally to that for the desktop computer. To enhance the user comfort of the keyboard 13 of the notebook computer 10, the present invention presents the consecutive adjacent rows R0 to R5 (FIG. 3) of the keyboard 13 with parallel arc rows arranged on the base 131, and thereby the more space for constructing the keys can be obtained. In addition, the present invention enlarges the key size of the frequent-use letter and numerical keys (most keys in rows R1 to R5 in FIG. 3) to 0.85-0.98 times of that of keys used on a desktop computer. Compared with the conventional keyboard of the notebook computer which provides the key with a size 0.7-0.8 times of the key size on the desktop computer, the user with the notebook computer 10 having the keyboard 13 of the present invention can have more comfort, and the comfort can even reach a state compared to that of using a desktop computer. Further, in order to arrange all the keys of the keyboard 13 into a predetermined area of the base 131, the present invention shrinks the key size of the less-use standard function keys (keys in rows R0 in FIG. 3) and cursor keys to 0.6-0.7 times of that of keys used on a desktop computer. It is noted that the usage frequency of the cursor keys are larger than that of the function keys, and the cursor keys usually meet a situation of simultaneous usage. Therefore, in the present invention, the group of cursor keys is arranged at a lower right position of the keyboard 13 where these keys can be easily reached by the finger.

Refer again to FIG. 3. In a typical arrangement of a conventional keyboard for the notebook computer, the arrangement is usually centered at a mid point 133 (cross point of dashed lines) between letters G and H. However, in the “QWERTY” standard keyboard, the number of the keys left to the mid point 133 is less than the number of the keys right to the mid point 133. Therefore, such an arrangement of the keys around the mid point 133 can cause different lengths of the key strings at opposing sides. Contrary, in the present invention, the key arrangement of the keyboard 13 in accordance with the “QWERTY” standard is centered at the center line 132 of the base 131 and thus the keys of the keyboard 13 can be evenly allotted to both sides of the center line 132. Also, the typing stroke of the keyboard 13 can thereby be shortened.

Also shown in FIG. 3, the keys of the present invention are arranged to form a plurality of rows on the base 131. Firstly, a plurality of non-standard function keys 135 are located to the up most edge of the base 131. The non-standard function keys 135 can be user's macro keys, one-click network keys, switch keys of radio communication, etc. Each of the non-standard function keys 135 can be provided, for example, to replace a serial of complicated inputs by a single click. Upon such an arrangement, cost for producing the keys can be reduced and the convenience of using the keyboard 13 can be increased. Secondly, in the present invention, the key size for the keys on the R0 row, the standard function keys of F1-F10 keys and the ESC key for examples, is made to be 0.6-0.7 times of that of keys used on a desktop computer; and the key size for the keys on rows R1-R5 is made, in accordance with the “QWERTY” standard, to be 0.85-0.98 times of that of keys used on a desktop computer. As shown, rows R1-R5 include the letter keys, the numeral keys, the Enter key, the Shift key, the Tab key, the Ctrl key and the space key. It is noted that rows R1-R5 are arc-arranged and have a concentric center 130 which lies at the extended center line 132 of the base 131 and at the side opposing to the user about the keyboard 13. Due to the same key size provided to the letter and the numeral keys in rows R1-R5, therefore rows R1-R5 are profiled as concentric arcs with equal spacing. Thereby, development cost for the keyboard can be reduced for the same tooling of the keys can be applied. In a preferred embodiment of the present invention, row R5 can have a radius of 1509.3 mm (measured from a center of the key to the center 130), and row R4 can have a radius of 1490.8 mm. Other radii for rest of the rows of the keyboard can also be obtained by easy deduction. Though the key size for row R0 is slightly less than that for rows R1-R5, yet row R0 and rows R1-R5 still have the same concentric center 130. Therefore, from simple deduction, row R0 of this embodiment can have a radius of 1420 mm.

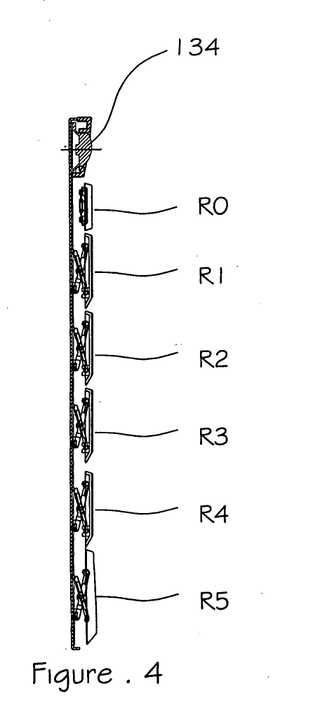

Referring now to FIG. 4, relationship between key rows of the keyboard 13 in accordance with the present invention can be easily observed. As shown, the function key 135 is a non-standard function key, and the keys of rows R0-R5 are parallel arranged in order on the base 131. By providing the present invention, the frequent-use keys of the keyboard 13 have preferable using space and compactly arranged at the center area of the base 131, while the less-use keys are shrunk to occupy the peripheral area of the base 131. Thereby, the ergonomic keyboard in accordance with the present invention can be provided.

The above description is only a preferred embodiment and is not intended to limit the scope of the present invention. Meanwhile, varies changes can be made, for example, the concentric center can be located at the user side of the keyboard, or the arrangement of the present keyboard can be used on the keyboard of a desk top computer. While the present invention has been particularly shown and described with reference to a preferred embodiment, it will be understood by those skilled in the art that various changes in form and detail may be without departing from the spirit and scope of the present invention.

1. An ergonomic keyboard, comprising:
a base; and
a plurality of keys, located evenly on the base about a center line of the base and further arranged to form a plurality of arc key rows having a concentric center lying at the center line, said keys are further arranged on said base in accordance with a “QWERTY” standard keyboard arrangement, said concentric center is located at a side opposing to a user of said keyboard;
wherein the width of each keys of said “QWERTY” standard keyboard arrangement is increasing radically from said concentric center.

2. The ergonomic keyboard according to claim 1, wherein said arc key rows are equal-spaced arranged.

3. The ergonomic keyboard according to claim 1, wherein said base further includes a plurality of non-standard function keys located at an upper edge thereof.

4. The ergonomic keyboard according to claim 3, wherein said non-standard function key is used to macro a plurality of serial typing operations for reducing the typing of said keys.

5. The ergonomic keyboard according to claim 1 further includes a pair of fasteners for fixing said keyboard to a computer unit.

6. A notebook computer, comprising:
a host unit for storage and for processing digital data;
a display unit for displaying said digital data; and
an ergonomic keyboard, fixed on the host unit, further comprising:
a base; and
a plurality of keys, located evenly on the base about a center line of the base and further arranged to form a plurality of arc key rows having a concentric center lying at the center line, said keys are further arranged on said base in accordance with a “QWERTY” standard keyboard arrangement, said concentric center is located at a side opposing to a user of said keyboard;
wherein the width of each keys of said “QWERTY” standard keyboard arrangement is increasing radically from said concentric center.

7. The notebook computer according to claim 6, wherein said arc key rows are equal-spaced arranged.

8. The notebook computer according to claim 6, wherein said arc key rows include letter keys and numeral keys and each of the letter keys and the numeral keys has a size 0.85-0.98 times of a key of a keyboard for a desktop computer.

9. The notebook computer according to claim 6, wherein said arc key rows include standard function keys and each of the standard function keys has a size 0.6-0.8 times of a key of a keyboard for a desktop computer.

10. The notebook computer according to claim 6, wherein said base further includes a plurality of non-standard function keys located at an upper edge thereof.

11. The notebook computer according to claim 10, wherein said non-standard function key is used to macro a plurality of serial typing operations for reducing the typing of said keys.

12. The notebook computer according to claim 6, wherein said ergonomic keyboard further includes a pair of fasteners for fixing said keyboard to said computer unit.
